(19) United States
(12) Patent Application Publication
(10) Pub. No.: US 2025/0334725 A1
(43) Pub. Date: Oct. 30, 2025

(54) Monolithic Homodyne Encoder

(71) Applicant: Naval Information Warfare Center Pacific, San Diego, CA (US)

(72) Inventor: Kyle DREXLER, San Diego, CA (US)

(73) Assignee: THE UNITED STATES OF AMERICA, AS REPRESENTED BY THE SECRETARY OF THE NAVY, San Diego, CA (US)

(21) Appl. No.: 18/651,299

(22) Filed: Apr. 30, 2024

(51) Int. Cl. G02B 5/18; G02B 1/00; G02B 26/06

(52) U.S. Cl. CPC G02B 5/1814; G02B 1/002; G02B 26/06

(57) ABSTRACT

A monolithic homodyne encoder is described herein. The monolithic homodyne encoder includes a diffractive optical slab. The diffractive optical slab includes a first side and a second side that are optically parallel to each other, a first set of phase maps on the first side of the diffractive optical slab that apply a spatial phase map to incoming light, and a second set of phase maps on the second side of the diffractive optical slab that directs the light to a component.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor. Licensing and technical inquiries may be directed to the Office of Research and Technical Applications, Naval Information Warfare Center Pacific, Code 72120, San Diego, CA, 92152; (619) 553-5118; NIWC_Pacific_T2@us.navy.mil. Reference Navy Case Number 211593.

### BACKGROUND

Light propagating through the Earth's atmosphere encounters atmospheric turbulence, which causes dynamic temperature and pressure fluctuations, and these fluctuations randomly vary the index of refraction throughout the Earth's atmosphere. Thus, light propagating through the Earth's atmosphere collects wavefront phase errors that degrade imaging performance through the atmospheric turbulence when compared to a homogenous environment such as the vacuum of space. This effect is particularly pronounced in astronomic telescope applications, but similar degradations may occur in other scenarios such as terrestrial telephoto imaging and airborne surveillance. A number of techniques are used to correct imaging distortion. For example, wavefront sensors (e.g., Shack-Hartmann wavefront sensor) with a beacon, one or more adaptive mirrors, and real-time digital processing compose the traditional adaptive optics techniques employed on many astronomy telescopes. Additionally, there are post-processing techniques that attempt to correct imaging distortion. These may include methods that build up temporal statistics of scene fluctuations or methods that attempt to estimate a blur kernel from a single image.

### DESCRIPTION OF THE DRAWINGS

Features and advantages of examples of the present disclosure will be apparent by reference to the following detailed description and drawings, in which like reference numerals correspond to similar, but in some instances, not identical, components. Reference numerals or features having a previously described function may or may not be described in connection with other drawings in which they appear.

FIG. 1 a cross-sectional example of the monolithic homodyne encoder disclosed herein focusing light onto a detector;

FIG. 2 is another cross-sectional example of the monolithic homodyne encoder disclosed herein focusing light onto a detector;

FIG. 3A-3B are examples of a front view and rear view, respectively, of the monolithic homodyne encoder disclosed herein; and

FIG. 4 is another cross-sectional example of the monolithic homodyne encoder disclosed herein aligning light onto a focusing optic.

### DETAILED DESCRIPTION

Current homodyne encoding devices rely on individual phase grating that are mounted within a mechanical structure that is then properly aligned. Other homodyne coding devices use a diffractive optical element that is bounded by mirrors to create the final homodyne interferometry device. These homodyne encoding devices inherently contain mechanical supports, internal to the interferometry device, that need to be mechanically locked after alignment. These mechanical support devices (e.g., springs or locks) are inherently susceptible to vibrations, which results in optical misalignment and failure of the homodyne encoding devices due to mirror movement or phase grating motion. Additionally, the springs of the homodyne encoding devices degrade with time, which also results in failure of the homodyne encoding devices.

The monolithic homodyne encoder described herein has no mechanical components. Therefore, the monolithic homodyne encoder is immune to internal vibrations that result in optical misalignment and failure of the homodyne encoder device. Additionally, the monolithic homodyne encoder is immune to degradation as no springs are being used. Along with the performance benefits, the monolithic homodyne encoder reduces integration time within the final system, which enables the monolithic homodyne encoder to be created faster compared to traditional homodyne encoder devices. The skill required to align the monolithic homodyne encoder is also significantly reduced allowing for more efficient alignment and reducing the training required to align the monolithic homodyne encoder.

A monolithic homodyne encoder is described herein that includes a diffractive optical slab. The diffractive optical slab includes a first side and a second side that are optically parallel to each other, a first set of phase maps on the first side of the diffractive optical slab that apply a spatial phase map to incoming light, and a second set of phase maps on the second side of the diffractive optical slab that directs the light to a component.

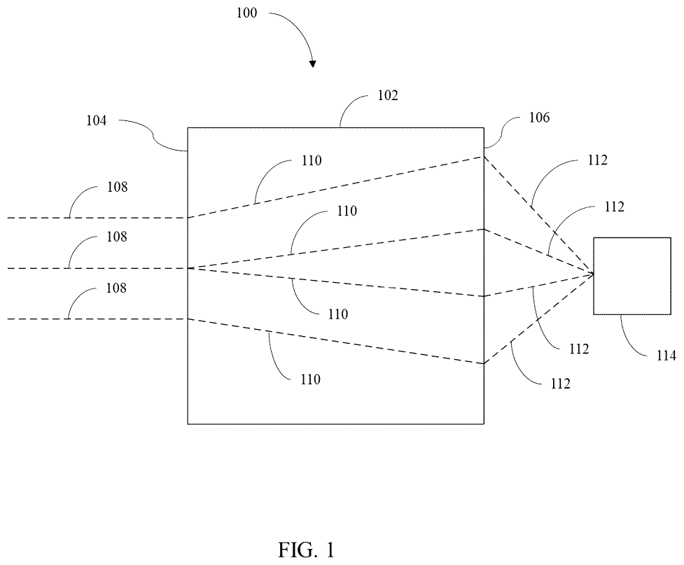

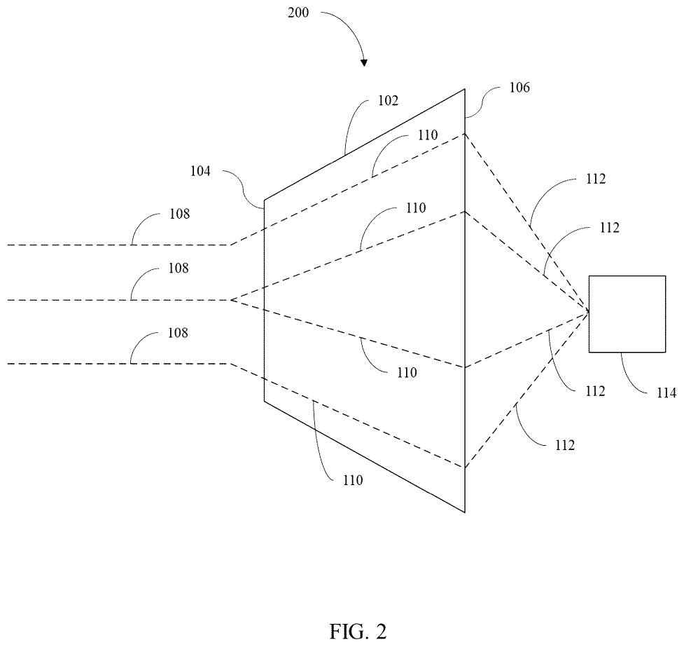

Referring now to FIG. 1 and FIG. 2, two examples of a monolithic homodyne encoder focusing light onto a detector is shown. In FIG. 1 and FIG. 2, any hatching patterning is for illustrative purposes only to aid in viewing and should not be construed as being limiting or directed to a particular material or materials. The monolithic homodyne encoder includes a diffractive optical slab 102. The diffractive optical slab 102 includes a first side 104 and a second side 106 that are optically parallel to each other. In an example, the first side 104 and the second side 106 are optically parallel to each other within an amount of equal to or less than λ/4. The diffractive optical slab 102 size is dependent on the first to second set of phase map pattern angles, the wavelength that is used in the encoder system, and the amount of distance for the light to go from the first set of phase maps to the second set of phase maps at a constant angle applied by the first set of phase maps. The diffractive optical slab 102 may be any shape that allows the monolithic encoder module 100 to function properly. In an example, the diffractive optical slab 102 may be a cube or a flat-topped pyramid with the first side 104 of the diffractive optical slab 102 being a top side of the flat-topped pyramid and the second side 106 of the diffractive optical slab 102 being a base of the flat-topped pyramid. An example of the diffractive optical slab 102 as a cube is shown in FIG. 1. An example of the diffractive optical slab 102 as a flat-topped pyramid is shown in FIG. 2. In an example, the diffractive optical slab 102 may be any type of optically transparent material, such as optical grade glass. In another example, the monolithic homodyne encoder 100 may include two or more diffractive optical slabs 102 bonded together via optical grade epoxy. In one example, the entire second side 106 of a diffractive optical slab 102 is bonded to the entire first side 104 of another diffractive optical slab 102. In another example, the edges of each diffractive optical slab 102 are bonded together with an air or gas gap in the center.

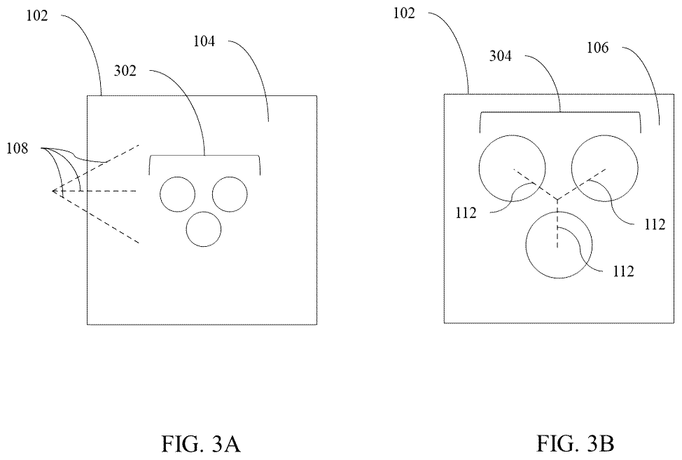

Referring now to FIG. 3A-3B, an example of the front view and rear view, respectively, of the monolithic homodyne encoder 100 is shown. In FIG. 3A and 3B, the diffractive optical slab 102 includes a first set of phase maps 302 on the first side 104 of the diffractive optical slab 102 that apply a spatial phase map to incoming light 108 and a second set of phase maps 304 on the second side 106 of the diffractive optical slab 102 that directs the light to a component. In FIG. 3A-3B, any hatching patterning is for illustrative purposes only to aid in viewing and should not be construed as being limiting or directed to a particular material or materials. The first and second set of phase maps 302, 304 may be any type of openings. In an example, the first set of phase maps 302 and the second set of phase maps 304 are gratings with apertures, metaoptic materials, such as dielectric nanostructures or silicon-based nanopillars, or a combination thereof. In an example, the first set of phase maps 302 is equal to or greater than 3 apertures in a non-overlapping, non-redundant pattern. FIG. 3A shows an example of the 3 apertures in a non-overlapping, non-redundant pattern. In another example, the first side 104 and the second side 106 of the diffractive optical slab 102 are optically opaque except for the first set of phase maps 302 and the second set of phase maps 304.

The pattern of the apertures in the first and second phase maps 302, 304 may be any non-overlapping, non-redundant pattern for the first set of phase maps 302 as long as the second set of phase maps 304 is in a Golay pattern with respect to the first set of phase maps 302. In another example, the second set of phase maps 304 are a Complex Conjugate of the first set of phase maps 302. The apertures of the first and second set of phase maps 302, 304 may be any diameter that is possible to manufacture. In an example, the second set of phase maps 304 have a diameter that is greater than the first set of phase maps 302. In FIG. 3B, an example of the second set of phase maps 304 having a larger diameter than the first set of phase maps 302 in FIG. 3A is shown. In another example, the first set of phase maps 302 may produce a final aperture separation of at least 2 times the diameter of the first set of phase maps 304. Similarly, the number of apertures may be any amount that is possible to manufacture. In an example, as shown in FIG. 3A and 3B, the number of apertures in the first set of phase maps 302 and second set of phase maps 304 are equal.

Referring back to FIG. 1 and FIG. 2, an example of the light interacting with the optical slab 102 is also shown. In the examples shown in FIG. 1 and FIG. 2, the incoming light 108 enters the diffractive optical slab 102 from the first side 104 via the first set of phase maps 302. After the light enters the diffractive optical slab 102, the light is diffracted (i.e., the diffracted light 110) at an angle by the apertures in the first set of phase maps 302. The angle of the diffracted light 110 is dependent on the wavelength of the light, the phase map manufacturing, and the size and position of the apertures. The diffracted light 110 travels through the diffractive optical slab 102 to the second side 106 of the diffractive optical slab 102. Once the light reaches the second side 106 of the diffractive optical slab 102, the diffracted light 110 enters the second set of phase maps 304. In FIG. 1 and FIG. 2, when the diffracted light 110 is collimated by the second set of phase maps 304. The collimated light 112 is focused onto a detector 114 in the examples shown in FIG. 1 and FIG. 2. The detector 114 detects an image of a target with the collimated light 112 from the diffractive optical slab 102. Any detector 114 may be used that is sensitive to the optical grating design. In an example, the detector 114 is a pixelated detector for detecting the image, which is a two-dimensional image of the target, with the collimated light 112. In an example, the target can be a known light source (i.e., for calibration) or an external target.

Similarly, in the front and rear view of the optical slab 102 in FIG. 3A and 3B, the incoming light 108 enters the diffractive optical slab 102 via the first set of phase maps 302 shown in FIG. 3A. When the collimated light 112 exits the optical slab 102, the collimated light 112 can be focused onto a component (not depicted), such as a detector 114 shown in FIG. 1 and FIG. 2. In some other examples, the light may be directed to (e.g., collimated, aligned, focused, etc.) other components, such as to a mirror to fold the light, a filter system such as a bandpass or spatial filter, a beam splitter to redirect some of the light to multiple lens, detector systems rather than a single detector, a focusing optic, a lens or series of lenses, or a combination thereof. In another example, any of the component examples may be used to focus the collimated light 112 onto a detector 114.

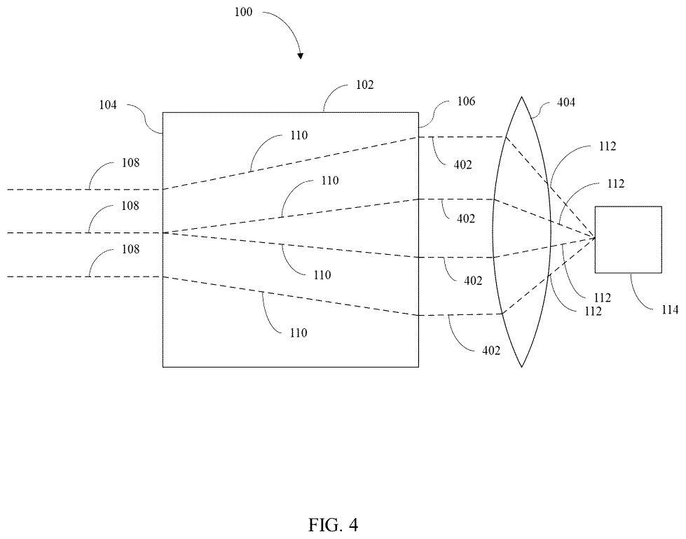

Referring now to FIG. 4, another example of the monolithic homodyne encoder 100 is shown. In this example, the diffractive optical slab 102 has a first set of phase maps 302 that diffract the incoming light 108. In FIG. 4, any hatching patterning is for illustrative purposes only to aid in viewing and should not be construed as being limiting or directed to a particular material or materials. The diffracted light 110 passes through the second set of phase maps 304 and is aligned by the second set of phase maps 304. The aligned light 402 is directed towards a focusing optic 404. The focusing optic 404 is a lens for collimating the aligned light 402 from the diffracted optical slab 102 onto the detector 114. The collimated light 112 from the focusing optic 404 generates an image of the target at the detector 114. In other examples, the focusing optic 404 may collimate light onto another component, such as a mirror to fold the light, a filter system such as a bandpass or spatial filter, a beam splitter to redirect some of the light to multiple lens, or detector systems rather than a single detector.

A method of making the monolithic homodyne encoder etching using any known etching technique, such as lithography, compressive molding, or additive manufacturing. A pattern is etched a first side and a second side of a diffractive optical slab. The pattern may be the same pattern as previously disclosed herein. The first side and the second side of the diffractive optical slab are optically parallel to each other. In an example, the first side and the second side are optically parallel to each other within an amount of equal to or less than λ/4. The first side includes a first set of phase maps that apply a spatial phase map to incoming light. The second side includes a second set of phase maps that directs the light to a component where the first set of phase maps and the second set of phase maps form the pattern that is etched into the first and second side of the diffractive optical slab.

The first set of phase maps and the second set of phase maps may be etched into a pattern of gratings as apertures, metaoptic materials, such as dielectric nanostructures or silicon-based nanopillars, or a combination thereof. The pattern of the apertures in the first set of phase maps may be equal to or greater than 3 apertures in any non-overlapping, non-redundant pattern for the as long as the second set of phase maps is in a Golay pattern with respect to the first set of phase maps. In another example, the second set of phase maps are a Complex Conjugate of the first set of phase maps. The apertures of the first and second set of phase maps may be any diameter that is possible to manufacture. In an example, the second set of phase maps have a diameter that is greater than the first set of phase maps. In another example, the first set of phase maps may produce a final aperture separation of at least 2 times the diameter of the first set of phase maps. Similarly, the number of apertures may be any amount that is possible to manufacture.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of a list should be construed as a de facto equivalent of any other member of the same list merely based on their presentation in a common group without indications to the contrary.

Unless otherwise stated, any feature described herein can be combined with any aspect or any other feature described herein.

Reference throughout the specification to “one example”, “another example”, “an example”, means that a particular element (e.g., feature, structure, and/or characteristic) described in connection with the example is included in at least one example described herein, and may or may not be present in other examples. In addition, the described elements for any example may be combined in any suitable manner in the various examples unless the context clearly dictates otherwise.

The ranges provided herein include the stated range and any value or sub-range within the stated range. For example, a range from about 0.1 to about 20 should be interpreted to include not only the explicitly recited limits of from about 0.1 to about 20, but also to include individual values, such as 3, 7, 13.5, etc., and sub-ranges, such as from about 5 to about 15, etc.

In describing and claiming the examples disclosed herein, the singular forms “a”, “an”, and “the” include plural referents unless the context clearly dictates otherwise.

What is claimed is:

1. A monolithic homodyne encoder, comprising:
a diffractive optical slab, wherein the diffractive optical slab includes a first side and a second side that are optically parallel to each other, a first set of phase maps on the first side of the diffractive optical slab that apply a spatial phase map to incoming light, and a second set of phase maps on the second side of the diffractive optical slab that directs the light to a component.

2. The monolithic homodyne encoder of claim 1, wherein the component is a detector and the diffractive optical slab directs the light onto a detector and the detector detects an image of a target with the light from the diffractive optical slab.

3. The monolithic homodyne encoder of claim 1, wherein the component is a focusing optic and the diffractive optical slab aligns the light onto the focusing optic.

4. The monolithic homodyne encoder of claim 3, wherein the focusing optic collimates the light before focusing the light onto a detector that detects an image of a target with the light from the focusing optic.

5. The monolithic homodyne encoder of claim 1, wherein the first side and the second side are optically parallel to each other within an amount of equal to or less than λ/4.

6. The monolithic homodyne encoder of claim 1, wherein the first set of phase maps and the second set of phase maps are gratings with apertures, metaoptic materials, or a combination thereof.

7. The monolithic homodyne encoder of claim 6, wherein the first set of phase maps is equal to or greater than 3 apertures in a non-overlapping, non-redundant pattern.

8. The monolithic homodyne encoder of claim 6, wherein the first set of phase maps produce a final aperture separation of at least 2 times the diameter of the first set of phase maps.

9. The monolithic homodyne encoder of claim 6, wherein a number of apertures in the first set of phase maps and the second set of phase maps are equal.

10. The monolithic homodyne encoder of claim 6, wherein the first set of phase maps and the second set of phase maps are apertures where the second set of phase maps have a diameter that is greater than the first set of phase maps.

11. The monolithic homodyne encoder of claim 6, wherein the second set of phase maps are a Complex Conjugate of the first set of phase maps.

12. The monolithic homodyne encoder of claim 1, wherein the diffractive optical slab has a shape that is a flat-topped pyramid with the first side of the diffractive optical slab being a top side of the flat-topped pyramid and the second side of the diffractive optical slab being a base of the flat-topped pyramid.

13. The monolithic homodyne encoder of claim 1, wherein the component is a mirror, a filter system, a beam splitter, a detector, a focusing optic, or a combination thereof.

14. The monolithic homodyne encoder of claim 1, further including one or more additional diffractive optical slabs bonded to the diffractive optical slab.

15. A method of making a monolithic homodyne encoder, comprising:
etching a pattern into a first side and a second side of a diffractive optical slab, wherein the first side and the second side that are optically parallel to each other, the first side includes a first set of phase maps that apply a spatial phase map to incoming light, and the second side includes a second set of phase maps that directs the light to a component where the first set of phase maps and the second set of phase maps form the pattern.

16. The method of claim 15, wherein the first side and the second side are optically parallel to each other within an amount of equal to or less than λ/4.

17. The method of claim 15, wherein the first set of phase maps and the second set of phase maps are apertures and the first set of phase maps is equal to or greater than 3 apertures in a non-overlapping, non-redundant pattern.

18. The method of claim 17, wherein the first set of phase maps produce a final aperture separation of at least 2 times the diameter of the first set of phase maps.

19. The method of claim 17, wherein a number of apertures in the first set of phase maps and the second set of phase maps are equal.

20. The method of claim 14, wherein the first set of phase maps and the second set of phase maps are gratings as apertures, metaoptic materials, or a combination thereof.
